(19) United States
(12) Patent Application Publication
(10) Pub. No.: US 2009/0190068 A1
(43) Pub. Date: Jul. 30, 2009

(54) LIGHT GUIDING BODY, SUBSTRATE FOR DISPLAY DEVICE, AND DISPLAY DEVICE

(75) Inventor: Tadashi Kawamura, Nara (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/067,661

(22) PCT Filed: Sep. 20, 2006
(86) PCT No.: PCT/JP2006/318619

§ 371 Date: May 8, 2008

(30) Foreign Application Priority Data
Sep. 22, 2005 (JP) 2005-276097

(51) Int. Cl. G02F 1/13357; F21V 8/00; G02B 6/10

(52) U.S. Cl. 349/65; 362/618; 385/131

(57) ABSTRACT

A display device higher in light use efficiency than conventional ones, a display device substrate suitably used for such a display device, and a light guide suitably used for an illuminator of such a display device are provided. The light guide has a plane of incidence on which light is incident and a plane of emergence from which light emerges, and has a first photonic crystal structure having a refractive index changing periodically along a direction substantially parallel to the plane of emergence.

### BACKGROUND OF THE INVENTION

1. Field of the Invention

The present invention relates to a light guide for an illuminator provided in a display device. The present invention also relates to a substrate for a display device and a display device.

2. Description of the Related Art

In recent years, liquid crystal display devices have found use in OA equipment such as personal computers and AV equipment such as video cameras, taking advantage of their features of being thin and consuming low power.

A liquid crystal display device typically includes a liquid crystal panel having a liquid crystal layer and an illuminator (called a backlight) provided on the back of the liquid crystal panel. The liquid crystal panel modulates light emerging from the illuminator, to attain display.

The backlight is generally composed of a light source, a light guide, a reflector, a prism sheet and the like. Light emitted from the light source is guided into the liquid crystal display panel with the light guide. On the light guide, formed are prisms, grains and the like for extracting light that is propagating inside the light guide to the outside. See, for example, Japanese Laid-Open Patent Publication No. 8-94844.

The conventional liquid crystal display devices have a problem of being low in light use efficiency. A reason for this is that light emerging from the illuminator is mostly absorbed by a polarizing plate and a color filter while passing through the liquid crystal panel. Another reason is that the liquid crystal display panel has regions that do not contribute to display because light-shading members such as a black matrix and wirings are placed in such regions. The portion of light incident on such regions is therefore wasted.

### SUMMARY OF THE INVENTION

In order to overcome the problems described above, preferred embodiments of the present invention provide a display device higher in light use efficiency than conventional ones, a display device substrate suitably used for such a display device, and a light guide suitably used for an illuminator of such a display device.

A light guide according to a preferred embodiment of the present invention is a light guide having a plane of incidence on which light is incident and a plane of emergence from which light emerges, including: a first photonic crystal structure having a refractive index changing periodically along a first direction substantially parallel to the plane of emergence.

In one preferred embodiment, the first photonic crystal structure is selectively formed in specific regions.

In another preferred embodiment, the specific regions include a first region having a refractive index changing at a first period, a second region having a refractive index changing at a second period different from the first period, and a third region having a refractive index changing at a third period different from the first and second periods.

In yet another preferred embodiment, the light guide of the invention further includes a second photonic crystal structure having a refractive index changing periodically along a second direction substantially vertical to the plane of emergence.

In yet another preferred embodiment, the second photonic crystal structure is formed in regions nearer to the plane of emergence than the regions in which the first photonic crystal structure is formed.

In yet another preferred embodiment, the light guide of the invention is a light guide having a principal plane and a back plane opposite to each other and a plurality of side planes located between the principal plane and the back plane.

In yet another preferred embodiment, the plurality of side planes include a side plane functioning as the plane of incidence, and the principal plane functions as the plane of emergence.

In yet another preferred embodiment, the light guide of the invention further includes a third photonic crystal structure having a refractive index changing periodically along a third direction substantially parallel to the plane of emergence and crossing the first direction.

In yet another preferred embodiment, the third photonic crystal structure is formed in regions farther from the plane of emergence than the regions in which the first photonic crystal structure is formed.

In yet another preferred embodiment, the light guide of the invention further includes a light reflection layer placed on the side of the regions in which the third photonic crystal structure is formed opposite to the plane of emergence.

In yet another preferred embodiment, the occupation of the area of the regions in which the first photonic crystal structure is formed in the unit area of the plane of emergence when viewed from a normal to the plane of emergence is greater as the position is farther from the plane of incidence in the plane of emergence.

In yet another preferred embodiment, the back plane functions as the plane of incidence, and the principal plane functions as the plane of emergence.

In yet another preferred embodiment, the first photonic crystal structure is formed in a plurality of principal-side regions located near the principal plane and in a plurality of back-side regions located near the back plane.

In yet another preferred embodiment, the light guide of the invention further includes at least one principal-side light reflection layer formed between the plurality of principal-side regions and at least one back-side light reflection layer formed between the plurality of back-side regions.

The illuminator according to a preferred embodiment of the present invention includes a light source and the light guide described above for guiding light emitted from the light source in a predetermined direction.

A display device according to a preferred embodiment of the present invention includes the illuminator having the configuration described above, and a display panel having a plurality of pixels, for performing display using light emerging from the illuminator.

In a preferred embodiment, the light guide has the first photonic crystal structure for each region corresponding to each of the plurality of pixels of the display panel.

In another preferred embodiment, light emerges from the region of the light guide corresponding to each of the plurality of pixels in a plurality of directions.

In yet another preferred embodiment, the first photonic crystal structure is formed in a region that does not substantially overlap a light-shading member in the display panel.

In yet another preferred embodiment, the first substrate and/or the second substrate has an orientation regulating member provided for each of the plurality of pixels, and the first photonic crystal structure is formed in a region that does not substantially overlap the orientation regulating member.

A display device substrate according to a preferred embodiment of the present invention is a display device substrate having a principal plane and a back plane opposite to each other and a plurality of side planes located between the principal plane and the back plane, the substrate including: a first photonic crystal structure having a refractive index changing periodically along a first direction substantially parallel to the principal plane.

In a preferred embodiment, the first photonic crystal structure is selectively formed in specific regions.

In another preferred embodiment, the specific regions include a first region having a refractive index changing at a first period, a second region having a refractive index changing at a second period different from the first period and a third region having a refractive index changing at a third period different from the first and second periods.

In yet another preferred embodiment, the display device substrate of the invention further includes a second photonic crystal structure having a refractive index changing periodically along a second direction substantially vertical to the principal plane.

In yet another preferred embodiment, the second photonic crystal structure is formed in regions nearer to the principal plane than the regions in which the first photonic crystal structure is formed.

In yet another preferred embodiment, the display device substrate of the invention further includes a third photonic crystal structure having a refractive index changing periodically along a third direction substantially parallel to the principal plane and crossing the first direction.

In yet another preferred embodiment, the third photonic crystal structure is formed in regions nearer to the back plane than the regions in which the first photonic crystal structure is formed.

In yet another preferred embodiment, the display device substrate of the invention further includes a light reflection layer placed on the back plane side of the regions in which the third photonic crystal structure is formed.

In yet another preferred embodiment, the occupation of the area of the regions in which the first photonic crystal structure is formed in the unit area of the principal plane when viewed from a normal to the principal plane is greater as the position is farther from a given side plane among the plurality of side planes in the principal plane.

In yet another preferred embodiment, the first photonic crystal structure is formed in a plurality of principal-side regions located near the principal plane and in a plurality of back-side regions located near the back plane.

In yet another preferred embodiment, the display device substrate of the invention further includes at least one principal-side light reflection layer formed between the plurality of principal-side regions and at least one back-side light reflection layer formed between the plurality of back-side regions.

A display device according to a preferred embodiment of the present invention is a display device having a plurality of pixels, including: a first substrate; a second substrate opposing to the first substrate; and a light modulation layer interposed between the first and second substrates, wherein the first substrate is the display device substrate having the configuration described above.

In a preferred embodiment, the first substrate has the first photonic crystal structure for each of the plurality of pixels.

In another preferred embodiment, the first photonic crystal structure is formed in a region that does not substantially overlap a light-shading member.

In yet another preferred embodiment, the first substrate and/or the second substrate has an orientation regulating member provided for each of the plurality of pixels, and the first photonic crystal structure is formed in a region that does not substantially overlap the orientation regulating member.

A display device according to a preferred embodiment of the present invention is a display device having a plurality of pixels, including: a first substrate having a principal plane; a second substrate opposing to the first substrate; and a light modulation layer interposed between the first and second substrates, wherein the first substrate has a first photonic crystal structure having a refractive index changing periodically along a first direction substantially parallel to the principal plane for each of the plurality of pixels.

In a preferred embodiment, the plurality of pixels include first color pixels outputting first color light, second color pixels outputting second color light different from the first color light, and third color pixels outputting third color light different from the first color light and the second color light, the first photonic crystal structure in the first color pixels has a first period, the first photonic crystal structure in the second color pixels has a second period different from the first period, and the first photonic crystal structure in the third color pixels has a third period different from the first period and the second period.

In another preferred embodiment, the first photonic crystal structure is formed in a region that does not substantially overlap a light-shading member.

In yet another preferred embodiment, the first substrate and/or the second substrate has an orientation regulating member provided for each of the plurality of pixels, and the first photonic crystal structure is formed in a region that does not substantially overlap the orientation regulating member.

In yet another preferred embodiment, the first substrate has a second photonic crystal structure having a refractive index changing periodically along a second direction substantially vertical to the principal plane.

In yet another preferred embodiment, the second photonic crystal structure is formed in regions nearer to the principal plane than regions in which the first photonic crystal structure is formed.

In yet another preferred embodiment, the display device of the invention further includes a light source.

In yet another preferred embodiment, the first substrate further has a back plane opposite to the principal plane and a plurality of side planes located between the principal plane and the back plane, and the plurality of side planes include a side plane on which light emitted from the light source is incident.

In yet another preferred embodiment, the first substrate has a third photonic crystal structure having a refractive index changing periodically along a third direction substantially parallel to the principal plane and crossing the first direction.

In yet another preferred embodiment, the third photonic crystal structure is formed in regions farther from the principal plane than the regions in which the first photonic crystal structure is formed.

In yet another preferred embodiment, the first substrate has a light reflection layer placed on the side of the regions in which the third photonic crystal structure is formed opposite to the principal plane.

In yet another preferred embodiment, in each of the plurality of pixels, the occupation of the area of the regions in which the first photonic crystal structure is formed in the principal plane when viewed from a normal to the principal plane is greater as the position of the pixel is farther from the side plane on which light is incident.

In yet another preferred embodiment, the first substrate further has a back plane opposite to the principal plane and a plurality of side planes located between the principal plane and the back plane, and light emitted from the light source is incident on the back plane.

In yet another preferred embodiment, the first photonic crystal structure is formed in a plurality of principal-side regions located near the principal plane and in a plurality of back-side regions located near the back plane.

In yet another preferred embodiment, the first substrate has at least one principal-side light reflection layer formed between the plurality of principal-side regions and at least one back-side light reflection layer formed between the plurality of back-side regions.

In yet another preferred embodiment, the light modulation layer is a liquid crystal layer.

According to a preferred embodiment of the present invention, a display device higher in light use efficiency than conventional ones is provided. Also, according to a preferred embodiment of the present invention, a display device substrate suitably used for such a display device, and a light guide suitably used for an illuminator of such a display device are provided.

Other features, elements, processes, steps, characteristics and advantages of the present invention will become more apparent from the following detailed description of preferred embodiments of the present invention with reference to the attached drawings.

### BRIEF DESCRIPTION OF DRAWING

FIG. 1 is a cross-sectional view diagrammatically showing a liquid crystal display device 100 according to a preferred embodiment of the present invention.

FIG. 2 is a cross-sectional view diagrammatically showing an illuminator provided in the liquid crystal display device 100.

FIG. 3 is a perspective view diagrammatically showing an example of photonic crystal structure.

FIG. 4 is a view showing a preferred positional relationship between a region in which a photonic crystal layer is placed and a pixel.

FIG. 5 is a view showing an example of preferred positional relationship between light-shading members/orientation regulating members in a pixel and the photonic crystal structure.

FIG. 6 is a cross-sectional view diagrammatically showing another light guide used for the illuminator of the liquid crystal display device 100.

FIG. 7 is a cross-sectional view diagrammatically showing yet another light guide used for the illuminator of the liquid crystal display device 100.

FIGS. 8A and 8B are views for explaining to what extent light emitted from a light source attenuates as passing through components of a liquid crystal display device.

FIG. 9 is a perspective view diagrammatically showing an illuminator having an LED as the light source.

FIG. 10A is a graph showing an example of spectrum of an LED used as the light source of the illuminator, and FIG. 10B is a graph showing an example of spectrum of a cold-cathode tube used as the light source of the illuminator.

FIGS. 11A, 11B and 11C are views showing preferred configurations for introducing light from a light source into a light guide.

FIG. 12A is a view for explaining a function of a first photonic crystal layer, and FIGS. 12B and 12C are views showing specific examples of first photonic crystal structure.

FIG. 13A is a view showing an example of one-layer first photonic crystal structure, and FIG. 13B is a view showing an example of two-layer first photonic crystal structure.

FIGS. 14A to 14E are cross-sectional views showing steps of an exemplified method for forming a multi-layer first photonic crystal structure.

FIG. 15 is a microscope photograph of an actually prototyped silicon mold.

FIG. 16 is a microscope photograph of an actually prototyped two-layer first photonic crystal structure.

FIG. 17 is a graph showing the polarization separation characteristic of the first photonic crystal structure of FIG. 16.

FIG. 18 is a graph showing the wavelength separation characteristic of the first photonic crystal structure of FIG. 16.

FIG. 19A is a view for explaining a function of a second photonic crystal layer, and FIGS. 19B and 19C are views showing specific examples of second photonic crystal structure.

FIG. 20A is a view for explaining a function of a third photonic crystal layer, and FIG. 20B is a view showing a specific example of third photonic crystal structure.

FIGS. 21A to 21C are views showing examples of control of directions of emergence of light.

FIG. 22 is a view showing a light guide outputting light from a region thereof corresponding to one pixel in a plurality of directions.

FIG. 23 is a view for explaining simulation results on the relationship between the period of the refractive index and the direction of emergence of light.

FIG. 24A to 24F are views showing the results of simulation of the direction of emergence of light observed when the pitch P is varied.

FIG. 25 is a graph showing the relationship between the pitch P (μm) and the angle of emergence (°).

FIG. 26 is a cross-sectional view diagrammatically showing a liquid crystal display device 200 of another preferred embodiment of the present invention.

FIG. 27 is a cross-sectional view diagrammatically showing an illuminator provided in the liquid crystal display device 200.

FIG. 28 is a cross-sectional view diagrammatically showing a liquid crystal display device 300 of yet another preferred embodiment of the present invention.

FIG. 29 is a view showing an example of preferred positional relationship between light-shading members/orientation regulating member in a pixel and a photonic crystal structure.

FIG. 30 is a cross-sectional view diagrammatically showing another back substrate used for an illuminator of the liquid crystal display device 300.

FIG. 31 is a cross-sectional view diagrammatically showing yet another back substrate used for an illuminator of the liquid crystal display device 300.

### DETAILED DESCRIPTION OF THE PREFERRED EMBODIMENTS

In recent years, research/development of various optical devices using “photonic crystal” have been underway. The photonic crystal is an artificial dielectric grating in which two or more kinds of materials different in refractive index (dielectric constant) are arranged periodically in a size about equivalent to the wavelength of light or smaller, and has a unique light propagation characteristic.

The present invention embodies a display device higher in light use efficiency than conventional ones by forming a photonic crystal structure on a light guide and a display device substrate.

Hereinafter, preferred embodiments of the present invention will be described with reference to the accompanying drawings. Note however that the present invention is not limited to the preferred embodiments to follow.

### Preferred Embodiment 1

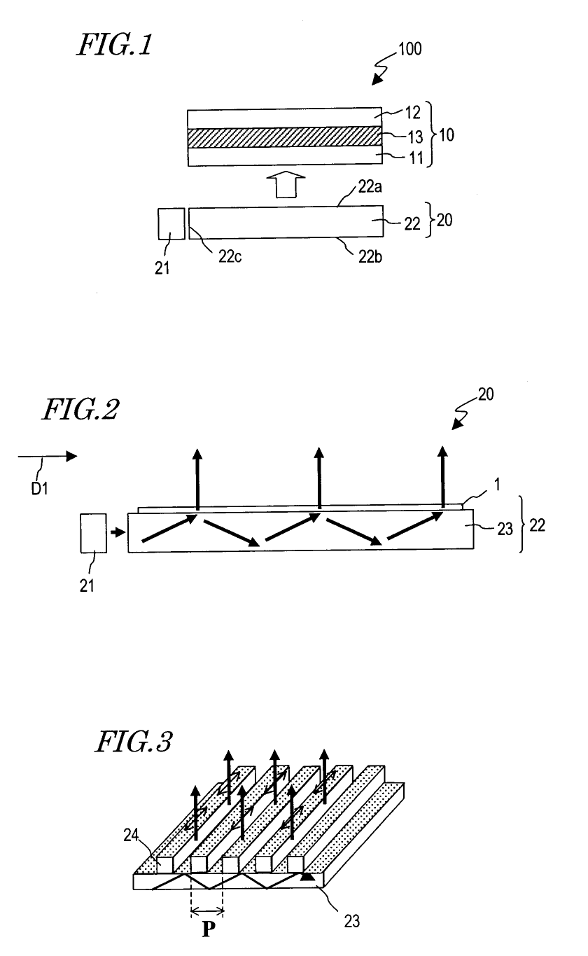

FIG. 1 shows a liquid crystal display device 100 of this preferred embodiment. The liquid crystal display device 100 includes a liquid crystal display panel 10 having a plurality of pixels and an illuminator 20 placed on the back side of the liquid crystal display panel 10.

The liquid crystal display panel 10 includes a pair of substrates 11 and 12 and a liquid crystal layer 13 interposed therebetween, to perform display using light emerging from the illuminator 20. The liquid crystal display panel 10 can adopts a variety of known display modes such as a twisted nematic (TN) mode, an electrically controlled birefringence (ECB) mode, a multi-domain vertical alignment (MVA) mode and a continuous pinwheel alignment (CPA) mode.

The illuminator 20 has a light source 21 and a light guide 22 for guiding light emitted from the light source 21 in a predetermined direction. The light source 21 may be a light emitting diode (LED) and a cold-cathode tube, for example.

The light guide 22 is a light guiding plate having a principal plane 22a and a back plane 22b facing each other and a plurality of side planes located between the principal plane 22a and the back plane 22b. A side plane 22c facing the light source 21, which is located on a side of the light guide 22, functions as the plane of incidence that receives light (i.e., on which light is incident). The principal plane 22a functions as the plane of emergence from which light emerges.

Hereinafter, the structure of the light guide 22 in this preferred embodiment will be described in a more specific way.

The light guide 22 in this preferred embodiment is completely different from conventional light guides in the point of having a “photonic crystal structure” in which the refractive index changes periodically. The light guide 22, having the photonic crystal structure, has a light propagation characteristic different from that of conventional light guides as will be described later.

As shown in FIG. 2, the light guide 22 specifically has a transparent substrate 23 and a photonic crystal layer 1 located on the transparent substrate 23. The photonic crystal layer 1 has a photonic crystal structure whose refractive index changes periodically along a direction D1 substantially parallel to the plane of emergence 22a.

An example of the photonic crystal structure is shown in FIG. 3. The photonic crystal structure of FIG. 3 has a plurality of rectangular or substantially rectangular columns 24 arranged regularly. The refractive indexes of the material of the rectangular or substantially rectangular columns 24 and the material surrounding these columns are preferably different from each other, to form the photonic crystal structure having a refractive index changing periodically along the direction D1. The period P of the refractive index is typically within the range of about 100 nm to about 500 nm, for example. Note that the structure shown in FIG. 3 is a mere example of the photonic crystal structure, and the photonic crystal structure can be in a variety of forms as will be detailed later.

Light emitted from the light source 21 enters the light guide 22 through the plane of incidence 22c. The light that has entered the light guide 22 propagates inside the light guide 22 by repeating total reflection from the principal plane 22a and the back plane 22b and, during this process, is incident on the photonic crystal layer 1.

The photonic crystal layer 1, having the photonic crystal structure described above, can direct the light incident thereon toward the direction normal to the plane of emergence 22a. The light guide 22 can therefore guide light from the light source 21 into the liquid crystal panel 10. Also, since the photonic crystal structure has a polarization selection characteristic and a wavelength selection characteristic, the photonic crystal layer 1 can selectively output light in a specific wavelength range and light having a specific polarization direction.

As described above, the light guide 22 according to a preferred embodiment of the present invention utilizes the characteristic of photonic crystal of being able to extract light in a specific wavelength range and light having a specific polarization direction with high energy efficiency. The photonic crystal layer 1 therefore can exert, not only the control of the direction of emergence, but also the functions of polarization separation and wavelength separation. This permits improvement in the light use efficiency of the display device in the following ways.

First, the light guide 22 can selectively output light having a specific polarization direction (linearly polarized light oscillating in a specific direction). Specifically, as shown in FIG. 3, the light wave 22 can selectively output light having a polarization direction perpendicular or substantially perpendicular to the direction D1 of the period of the refractive index. This makes it possible to omit a polarizing plate to be placed on the back side of the liquid crystal layer 13, and thus suppress absorption of light at the polarizing plate.

Also, the light guide 22 can selectively output light in a specific wavelength range. The wavelength selection characteristic of the photonic crystal structure depends on the length of the period of the refractive index. Therefore, by adjusting the period of the refractive index, light of a desired color in the visible light propagating inside the light guide 22 can be outputted. For example, the refractive index of a first photonic crystal structure may be changed at a first period in a given region of the light guide 22, changed at a second period different from the first period in another region thereof, and changed at a third period different from both the first and second periods in yet another region thereof, to thereby permit emergence of three kinds of color light (red, green and blue light rays, for example). This makes it possible to omit a color filter to be placed on the liquid crystal layer panel 10, and thus prevent absorption of light at the color filter.

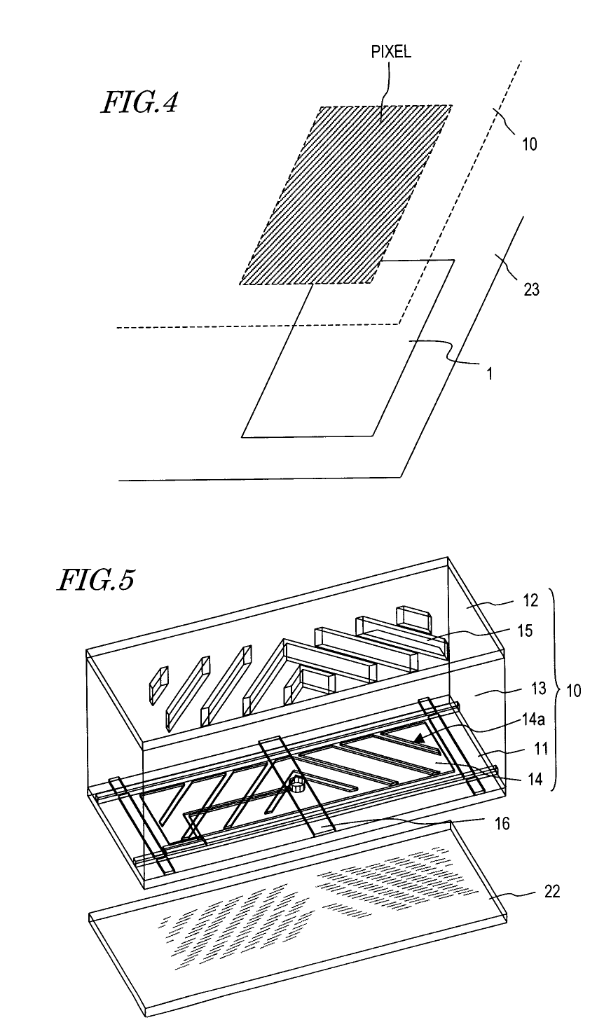

In FIG. 2, the photonic crystal layer 1 is shown as being disposed over roughly the entire surface of the transparent substrate 23. Actually, it is unnecessary to form the photonic crystal structure over the entire surface of the transparent substrate 23. FIG. 4 shows a preferred correspondence between a region of the light guide 22 where the photonic crystal layer 1 is actually placed and a pixel of the liquid crystal display panel 10. As shown in FIG. 4, the photonic crystal structure is selectively formed only in a specific region of the light guide 22 corresponding to each pixel of the liquid crystal panel 10. This prevents incidence of light on non-pixel regions that do not contribute to display and thus improves the light use efficiency.

It is also unnecessary to form the photonic crystal structure over the entire of each pixel. Each pixel has light-shading members such as a switching element (TFT, for example) and a storage capacitance line, and the regions of such members do not contribute to display. In addition, depending on the display mode, orientation regulating members such as protrusions and openings (openings formed in an electrode) may be provided to regulate the orientation of the liquid crystal layer. Since a sufficient voltage is not applied to liquid crystal molecules located right above and below these members, regions in which these members are provided may not sufficiently contribute to display. In view of these points, by forming the photonic crystal structure not to overlap such light-shading members and orientation regulating members in the liquid crystal display panel 10, the light use efficiency can be further enhanced.

FIG. 5 shows an example of preferred positional relationship between light-shading members/orientation regulating members in a pixel and the photonic crystal structure.

In the liquid crystal display panel 10 shown in FIG. 5, which adopts the MVA mode for display, the orientation of the liquid crystal layer 13 is regulated with openings 14a formed in a pixel electrode 14 on the TFT substrate 11 and protrusions (ribs) 15 formed on the color filter substrate 12. In the light guide 22 shown in FIG. 5, the photonic crystal structure is formed not to overlap the openings 14a and the protrusions 15 and also formed not to overlap a storage capacitance line 16. Thus, light is allowed to be incident intensively only on regions actually contributing to display.

Naturally, the amount of light propagating inside the light guide 22 becomes smaller as the position from the light source 21 is farther. Therefore, if the photonic crystal structure is formed on the light guide 22 at a uniform density, the uniformity of light emerging from the plane of emergence 22a may sometimes be low. In view of this, the photonic crystal structure may be formed so that the proportion of the area of regions having the photonic crystal structure in each unit area of the plane of emergence 22a when viewed from the normal to the plane of emergence 22a is greater as the position is farther from the plane of incidence 22c. That is, the photonic crystal structure may be formed denser as the position is farther from the light source 21. In this way, the uniformity of light emerging from the plane of emergence 22a can be made high.

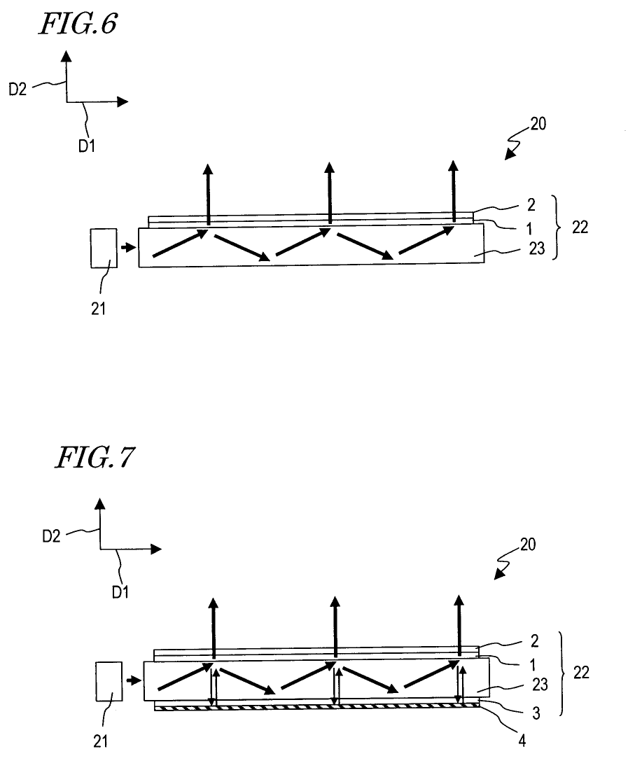

FIG. 6 shows another example of the light guide 22, which is different from the light guide 22 of FIG. 2 in that an additional photonic crystal layer 2 is formed on the photonic crystal layer 1.

The photonic crystal layer 2 has a photonic crystal structure in which the refractive index changes periodically in a direction D2 substantially vertical to the plane of emergence 22a. As used herein, the photonic crystal layer 1 and the photonic crystal structure thereof are respectively called the “first photonic crystal layer” and the “first photonic crystal structure”, and the photonic crystal layer 2 and the photonic crystal structure thereof are respectively called the “second photonic crystal layer” and the “second photonic crystal structure”.

Since the second photonic crystal layer 2 is formed on the first photonic crystal layer 1, the second photonic crystal structure is in a region nearer to the plane of emergence 22a than the region in which the first photonic crystal structure is formed. With the formation of the second crystal structure at a position nearer to the plane of emergence 22a than the first photonic crystal structure, the polarization separation and the wavelength separation can be performed more reliably.

The first photonic crystal layer 1 extracts light having a specific polarization direction selectively and directs it normal to the plane of emergence 22a as described above. At this time, light having a polarization direction orthogonal to the polarization direction of the extracted light is made to travel in the opposite direction. A structure for utilizing such light may therefore be provided on the back plane 22b of the light guide 22. For example, by providing a wide-band 1/4λ plate and a light reflection layer, the polarization direction of light traveling in the opposite direction can be rotated about 90°, to thereby change such oppositely traveling light to light extractable with the first photonic crystal layer 1.

FIG. 7 shows the light guide 22 provided with a wide-band 1/4λ plate and a light reflection layer. The light guide 22 of FIG. 7 includes a photonic crystal layer 3 and a light reflection layer 4 formed in this order on the surface of the transparent substrate 23 opposite to the surface on which the first photonic crystal layer 1 is formed.

The photonic crystal layer 3 has a photonic crystal structure in which the refractive index changes periodically along a direction substantially parallel to the plane of emergence 22a of the light guide 22 and crossing the direction D1 (at an angle of 45°, for example, with respect to the direction D1). As used herein, the photonic crystal layer 3 and the photonic crystal structure thereof are respectively called the “third photonic crystal layer” and the “third photonic crystal structure”.

Since the third photonic crystal layer 3 is arranged opposite to the first photonic crystal layer 1 with respect to the transparent substrate 23, the third photonic crystal structure is in a region farther from the plane of emergence 22a than the region in which the first photonic crystal structure is formed. The light reflection layer 4 is located opposite to the plane of emergence 22a with respect to the region in which the third photonic crystal structure is located (i.e., the third photonic crystal layer 3). The light reflection layer 4 is a reflecting plate made of metal, for example.

The third photonic crystal layer 3 having the third photonic crystal structure as described above can impart a phase difference to light made to travel toward the third photonic crystal layer 3 without being extracted with the first photonic crystal layer 1, and thus can function as a 1/4λ plate. By forming a phase plate in this way using the photonic crystal structure, it is possible to provide a 1/4λ plate corresponding to a wavelength range to which light is intended to change for each region corresponding to a pixel. Thus, a 1/4λ plate band-widened as a whole can be easily formed.

Hereinafter, specific estimation results on the effect of enhancing the light use efficiency according to the present invention will be described with reference to FIGS. 8A and 8B. FIGS. 8A and 8B are views diagrammatically showing to what extent light emitted from a light source attenuates as passing through components of a liquid crystal display device.

As shown in FIG. 8A, in a conventional liquid crystal display device, it is estimated that the surface reflection of light at incidence on a light guide from a light source is 10%, and that the attenuations through the light guide, a diffuser, a BEF/DBEF plate, a polarizing plate, a TFT substrate/liquid crystal layer, a color filter and another polarizing plate are respectively 20%, 3%, 14%, 12%, 59%, 72% and 2%. In this case, when the amount of light emitted from the light source is “100”, the amount of light finally emerging from the liquid crystal display device toward the observer is about “6”.

As shown in FIG. 8B, in the liquid crystal display device 100 of the present preferred embodiment of the present invention, it is estimated that the loss at introduction of light from the light source into the light guide is 50%, absorption by the photonic crystal structure is 5%, emergence from the end surface opposite to the light source is 20% and undesired radiation of light from the light guide is 20%, and that the attenuations through the TFT substrate/liquid crystal layer, the polarizing plate and a diffuser are respectively 10%, 2% and 20%. In this case, when the amount of light emitted from the light source is “100”, the amount of light finally emerging from the liquid crystal display device toward the observer is about “20”.

According to the estimation described above, the light use efficiency of the liquid crystal display device 100 of this preferred embodiment has enhanced three times that of the conventional liquid crystal display device. A reason for this is that in this preferred embodiment the polarizing plate on the back side of the liquid crystal layer and the color filter among the components of the liquid crystal display panel can be omitted. Another reason is that, with the selective formation of the photonic crystal structure in only specific regions, the attenuation through the TFT substrate/liquid crystal layer has widely decreased.

Hereinafter, more specific structures and preferred structures of the illuminator 20 of the liquid crystal display device 100 will be described components by components.

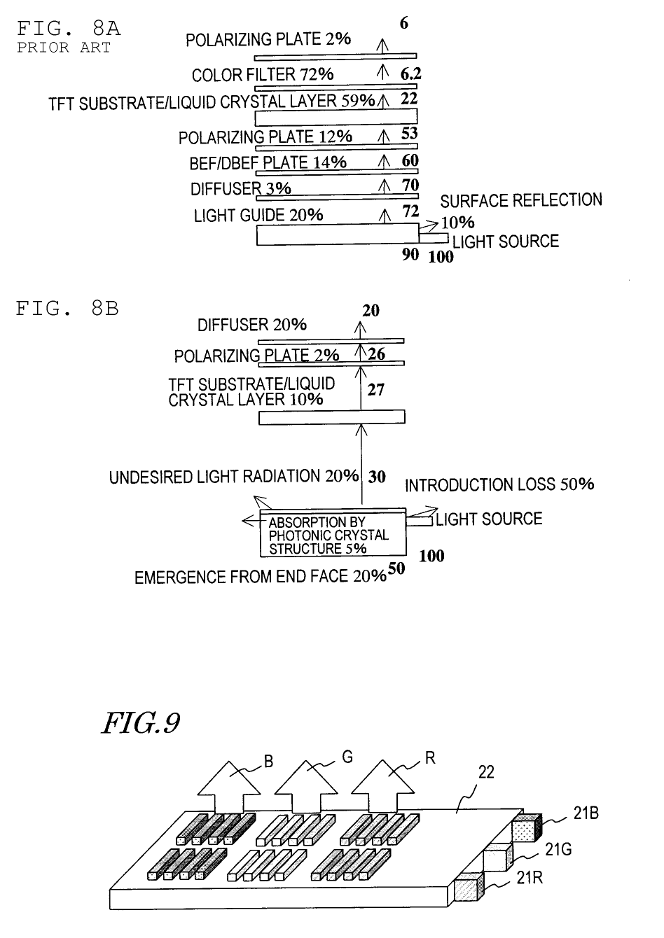

First, as the light source 21, a light emitting diode (LED) is preferably used from the standpoint of facilitating the design of the photonic crystal structure. The LED, capable of emitting single-wavelength light, facilitates the design of the photonic crystal structure. For example, in color display of the liquid crystal display panel with three types of pixels corresponding to R, G and B, three LEDs 21R, 21G and 21B emitting R, G and B light rays may be used as exemplified in FIG. 9.

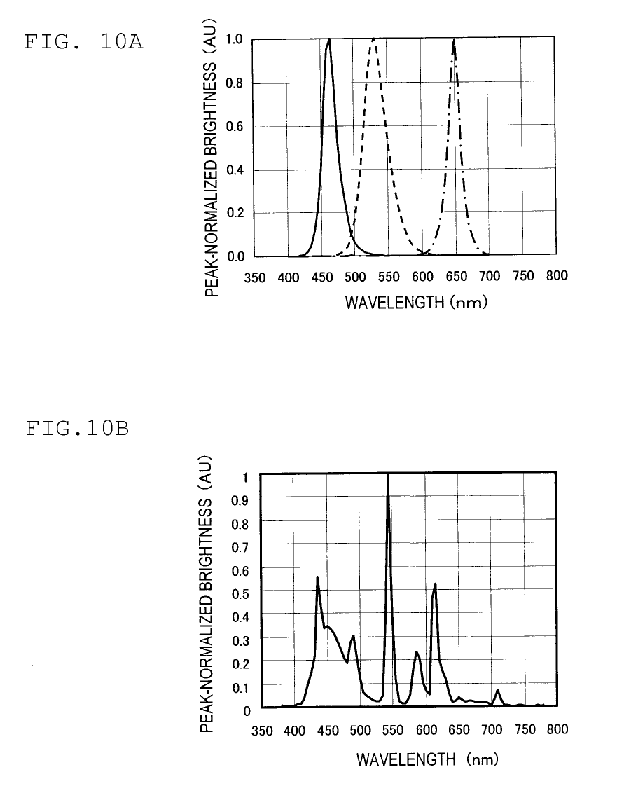

Naturally, the light source 21 may be a white light source such as a cold-cathode tube. Having sufficient wavelength separation by the photonic crystal structure, even a white light source can be used. FIGS. 10A and 10B respectively show examples of spectra of an LED and a cold-cathode tube usable in the liquid crystal display device 100. Either the LED having the spectrum shown in FIG. 10A or the cold-cathode tube having the spectrum shown in FIG. 10B can be used.

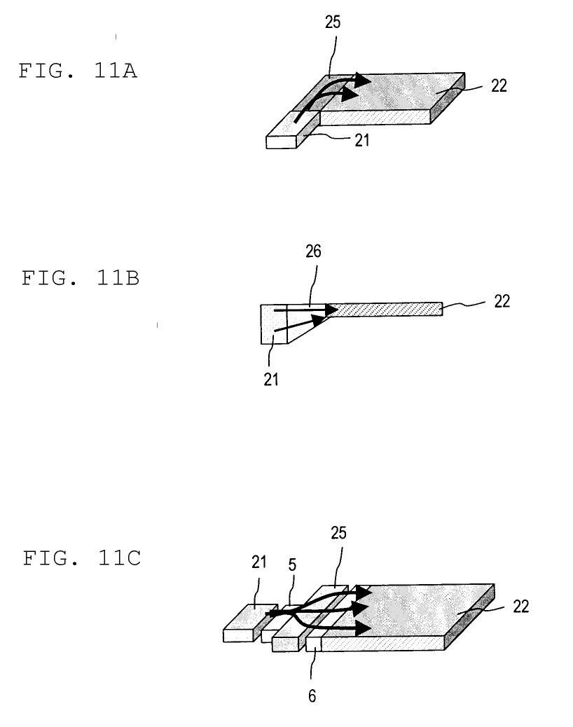

Light from the light source 21 may be made to directly enter the light guide 22 as shown in FIG. 9, or may be made to once enter a linear light guide 25 and then enter the light guide 22 as linear light as shown in FIG. 11A.

The light guide 22 having the photonic crystal structure is higher in light transmission efficiency when it is thinner (about 100 μm, for example). To introduce light from the light source 21 into a thin light guide 22 efficiently, however, it is preferred to provide an appropriate tapered shape and refractive index distribution. For example, as shown in FIG. 11B, it is preferred to provide a tapered light guide 26 tapering from the light-source side toward the light-guide side between the light source 21 and the light guide 22. Alternatively, as shown in FIG. 11C, in addition to the linear light guide 25 provided between the light source 21 and the light guide 22, photonic crystal layers 5 and 6 may be provided between the light source 21 and the linear light guide 25 and between the linear light guide 25 and the light guide 22, respectively. These photonic crystal layers 5 and 6 are provided to control the traveling direction of light incident thereon, to finally permit the light to enter the light guide 22 uniformly.

The transparent substrate 23 of the light guide 22, which is a plate-shaped member made of resin and glass, for example, functions as a waveguide for guiding light into the photonic crystal structure. The transparent substrate 23 is just required to allow light to propagate therein with a minimum of leakage outside, and thus not required to provide itself with a structure for extracting light and direct it normal to the plane of emergence 22a (prism, etc., for example). Incidentally, light that has reached the side surface opposite to the plane of incidence 22c without being extracted with the photonic crystal layer 1 will wastefully emerge from the side surface. It is therefore preferred to provide a structure that can return such light back into the inside. For example, a reflecting plate may be provided on the side surface opposite to the plane of incidence 22c.

The first photonic crystal layer 1 has a function of outputting light propagating inside the light guide 22 in the direction normal to the plane of emergence 22a, as shown in FIG. 12A. The first photonic crystal structure of the first photonic crystal layer 1 has a plurality of rectangular or substantially rectangular columns 24 arranged regularly (in stripes). The refractive indexes of the material of the rectangular or substantially rectangular columns 24 and the material surrounding these columns are different from each other, to attain periodic change in refractive index along the direction D1 substantially parallel to the plane of emergence 22a. If the direction of incidence of light on the first photonic crystal structure comparatively varies, a phase-displaced periodic structure as shown in FIG. 12C may preferably be formed.

Note that the unit structure of the first photonic crystal structure is not limited to those exemplified in FIGS. 12B and 12C. The unit structure is not limited to the rectangular or substantially rectangular column, but may be a cylindrical column or a triangular column. Also, the unit structure is not limited to the column structure, but may be a cone (pyramid) structure such as a circular cone, a triangular pyramid and a quadrangular pyramid, or otherwise a wall-like structure. Such column, pyramid and wall structures may be tilted with respect to the surface of the substrate 23. Alternatively, the unit structure may be a concave structure as inverted from the column structure (positive/negative reversed).

The first photonic crystal layer 1 can also perform polarization separation and wavelength separation (color separation). Although the single-layer first photonic crystal structures were shown in FIGS. 12B and 12C, the polarization separation characteristic and the wavelength separation characteristic can be enhanced by providing a multilayer (two or more layer) first photonic crystal structure (or an assembly of multilayer structures).

In a multilayer first photonic crystal structure, the layers may be equal to or different from each other in the period of the refractive index. No special consideration is necessary for the inter-layer phase relationship. In formation of a multilayer structure, it is unnecessary to design a strict refractive index periodic structure in the thickness direction (normal to the plane of emergence 22a), but is enough to just handle the multilayer structure as a stack of layers of diffraction grating different in structure. The spacing between any adjacent layers is preferably about 1 μm or more to ensure no binding between the two layers.

As the materials for forming the photonic crystal structure, a resin material and an inorganic material may be used. As a resin material, an ultraviolet cure resin and a thermosetting resin can be suitably used. As an inorganic material, a metal oxide such as TiO₂ (refractive index: 2.5), a metal and a porous material can be suitably used.

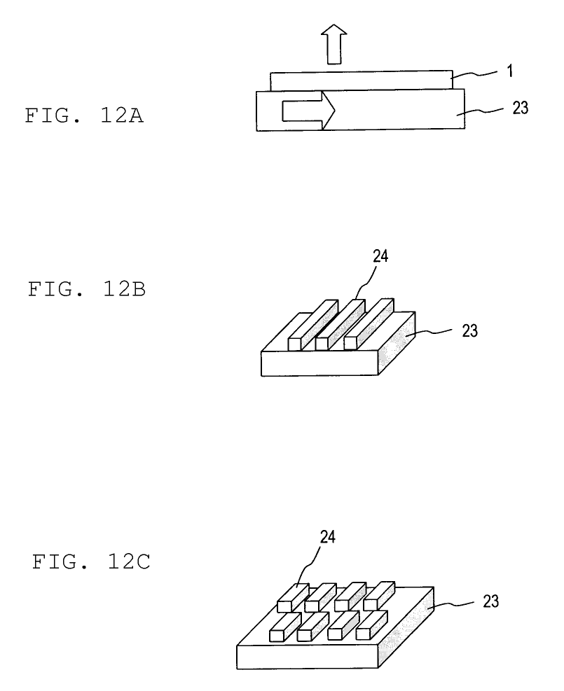

FIGS. 13A and 13B show examples of single-layer first photonic crystal structure and two-layer first photonic crystal structure, respectively.

In the example shown in FIG. 13A, a resin film 27 having rectangular or substantially rectangular column-shaped protrusions is formed on the surface of the transparent substrate as a glass substrate, and a TiO₂ film 28 is formed so as to cover the resin film 27. The pitch P1 and height h of the protrusions, the thickness t of the TiO₂ film 28 and the refractive indexes of the resin and TiO₂ are as listed in Table 1 below.

TABLE 1

| | | |
|---|---|---|
| Pitch | Red | 375 |
| P1 | (622 nm) | |
| (nm) | Green | 325 |
| | (530 nm) | |
| | Blue | 283 |
| | (470 nm) | |

| | |
|---|---|
| Height h (nm) | 50 |
| Thickness t of TiO₂ | 100 |
| film (nm) | |
| Refractive index of | 1.55 |
| resin | |
| Refractive index of | 2.5 |
| TiO₂ | |

In the example shown in FIG. 13B, a resin film 29 having rectangular or substantially rectangular column-shaped protrusions is further formed on the TiO₂ film 28. The pitches P1 and P2 and height h of the protrusions, the thickness t of the film 28, the inter-layer spacing d, and the refractive indexes of the resin and TiO₂ are as listed in Table 2 below.

TABLE 2

| | | |
|---|---|---|
| Pitch | Red | 350 |
| P1 = | (622 nm) | |
| P2 | Green | 300 |
| (nm) | (530 nm) | |
| | Blue | 270 |
| | (470 nm) | |

| | |
|---|---|
| Height h (nm) | 100 |
| Thickness t of TiO₂ | 20 |
| film (nm) | |
| Inter-layer spacing d | 3000 |
| (nm) | |
| Refractive index of | 1.55 |
| resin | |
| Refractive index of | 2.5 |
| TiO₂ | |

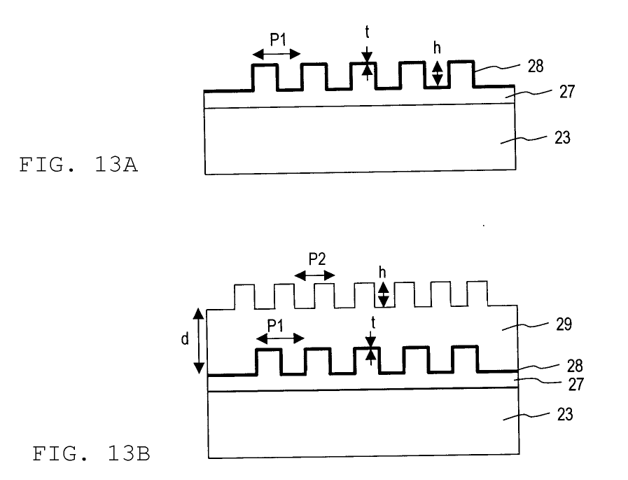

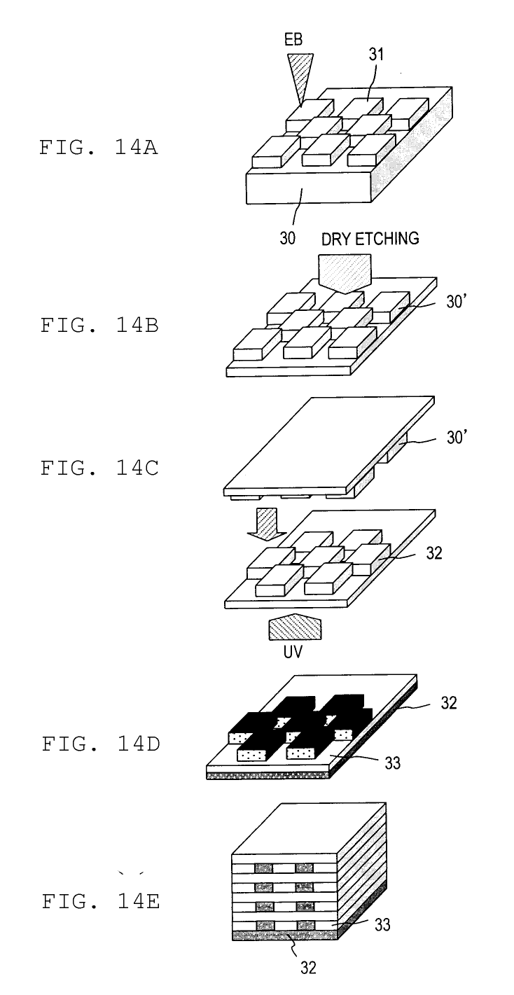

Hereinafter, an example of way of formation of a multilayer first photonic crystal structure will be described with reference to FIGS. 14A to 14E.

First, as shown in FIG. 14A, a predetermined pattern is drawn in an electron beam resist 31 provided on the principal plane of a silicon substrate 30 with electron beams (EB).

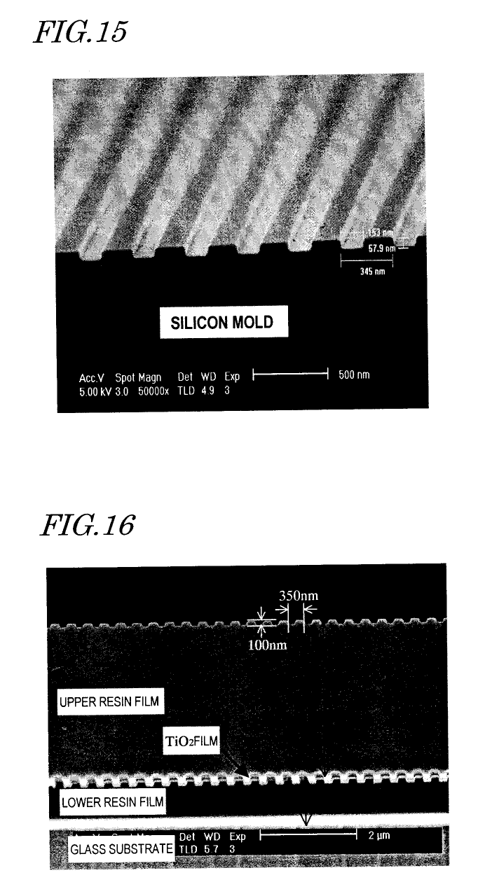

As shown in FIG. 14B, the silicon substrate 30 is subjected to dry etching (ICP etching, for example) to form a silicon mold 30′ reflecting the pattern of the electron beam resist 31. FIG. 15 shows a microscope photograph of the silicon mold 30′ actually prototyped. In this example, grooves having a depth of about 57.9 nm and a width of about 153 nm are arranged at a pitch of about 345 nm, for example.

Subsequently, as shown in FIG. 14C, the silicon mold 30′ is pressed against a resin film 32 made of an ultraviolet cure resin while the resin film 32 is irradiated with ultraviolet (UV) rays, so that the convex and concave shape of the silicon mold 30′ is transferred to the resin film 32.

As shown in FIG. 14D, a TiO₂ film 33 is formed on the resin film 32. Thereafter, the steps of FIGS. 14C and 14D are repeated by the number of times equal to a desired number of layers, to thereby obtain a multilayer first photonic crystal structure as shown in FIG. 14E.

FIG. 16 shows a microscope photograph of an actually prototyped two-layer first photonic crystal structure. As shown in the figure, the thickness of the lower resin film is about 1 μm, the thickness of the upper resin layer is about 3 μm, the height of the protrusions of the upper resin layer is about 100 nm, and the pitch of the protrusions is about 350 nm, for example.

The polarization separation characteristic of the first photonic crystal structure shown in FIG. 16 is shown in FIG. 17. As is found from FIG. 17, the intensity of TM polarized light is higher than that of TE polarized light in green light (wavelength: about 530 nm) (TM:TE=1.55:1), which indicates that the structure of FIG. 16 has a polarization separation characteristic.

The wavelength separation characteristic of the first photonic crystal structure of FIG. 16 is shown in FIG. 18. It is found from FIG. 18 that the wavelength separation, that is, color separation among red, green and blue has been well performed by the first photonic crystal structure.

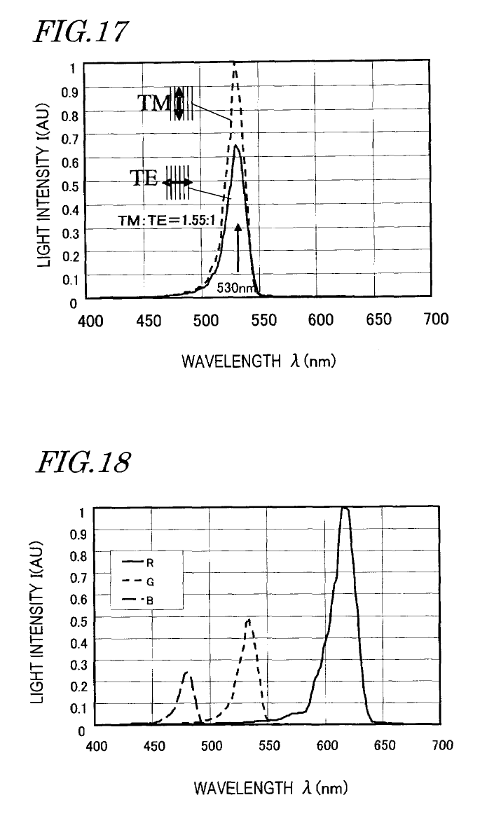

Next, the second photonic crystal layer 2 will be described. As shown in FIG. 19A, the second photonic crystal layer 2 is a layer for further performing wavelength separation and polarization separation for light directed to the normal to the plane of emergence 22a by the first photonic crystal layer 1, to thereby further enhance the wavelength separation characteristic and the polarization separation characteristic as the entire light guide 22.

Light traveling in the direction normal to the plane of emergence 22a mainly enters the second photonic crystal layer 2. For this reason, the second photonic crystal structure is required to have at least such a structure that the refractive index changes periodically along the normal to the plane of emergence 22a (i.e., along the thickness of the second photonic crystal layer 2). To sufficiently enhance the wavelength separation characteristic and the polarization separation characteristic, the second photonic crystal structure preferably includes five or more periods of refractive index periodic structure.

FIG. 19B shows an example of second photonic crystal structure. In the example of FIG. 19B), films 35, 36, . . . different in refractive index are sequentially formed on a previously formed concave and convex structure 34, to thereby form a refractive index periodic structure along the thickness direction. The example of FIG. 19B, which needs no precise positioning (positioning to the order of nm) such as repetition of imprinting, can be easily formed.

If the positioning margins in the plane and along the thickness are sufficiently secured (i.e., if phase matching in the plane is unnecessary and the variation in layer thickness is of the order of several hundreds of nm), the second photonic crystal structure may be formed by repetition of imprinting. In this case, a columnar two-dimensional structure as shown in FIG. 19C, for example, may be adopted as the unit structure.

Next, the third photonic crystal layer 3 will be described. As shown in FIG. 20A, the third photonic crystal layer 3 changes the polarization direction of light made to travel in the opposite direction without being extracted with the first photonic crystal layer 1. The third photonic crystal layer 3 therefore has the third photonic crystal structure in which the refractive index changes periodically along the direction substantially parallel to the plane of emergence 22a of the light guide 22 and crossing the refractive index periodic direction of the first photonic crystal structure (direction D1 in FIG. 7).

FIG. 20B shows an example of the third photonic crystal structure. In the example of FIG. 20B, a plurality of wall structures 37 are arranged on a surface of the transparent substrate 23 (surface opposite to the surface on which the first photonic crystal layer 1 is formed). The wall structures 37 have a height of about 1200 nm and are arranged at a pitch of about 400 nm, for example. As illustrated, the third photonic crystal structure functions as a phase plate having a fast axis parallel to the row of wall structures 37 and a slow axis orthogonal to the row of wall structures 37, and can function as a 1/4λ plate by arranging the slow axis to be at an angle of about 45° from the polarization direction of light from the first photonic crystal layer 1.

The description was made so far assuming the case that light emerges from the light guide 22 mainly in the direction normal to the plane of emergence 22a. In this case, the brightness of light is greatly unbalanced (the brightness in the direction normal to the plane of emergence is eminently high). To widen the viewing angle, therefore, light is preferably diffused after passing through the liquid crystal display panel 10.

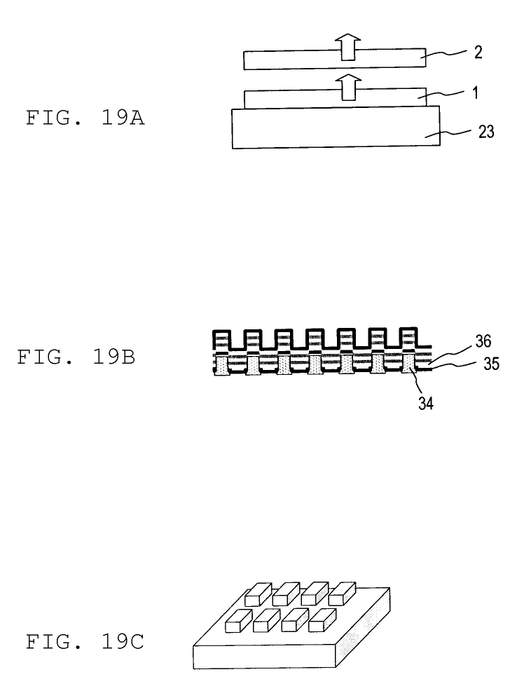

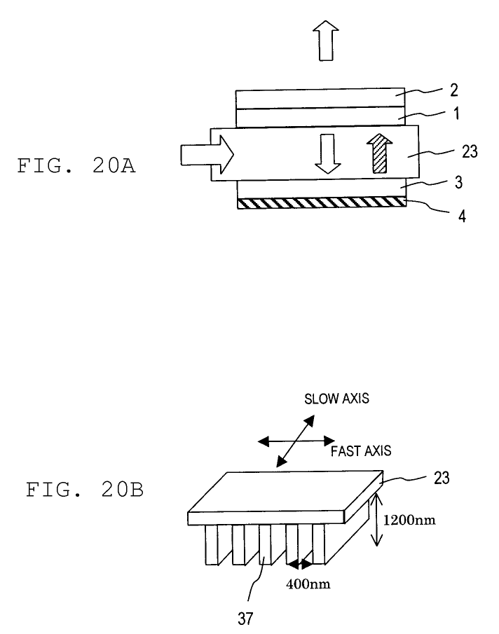

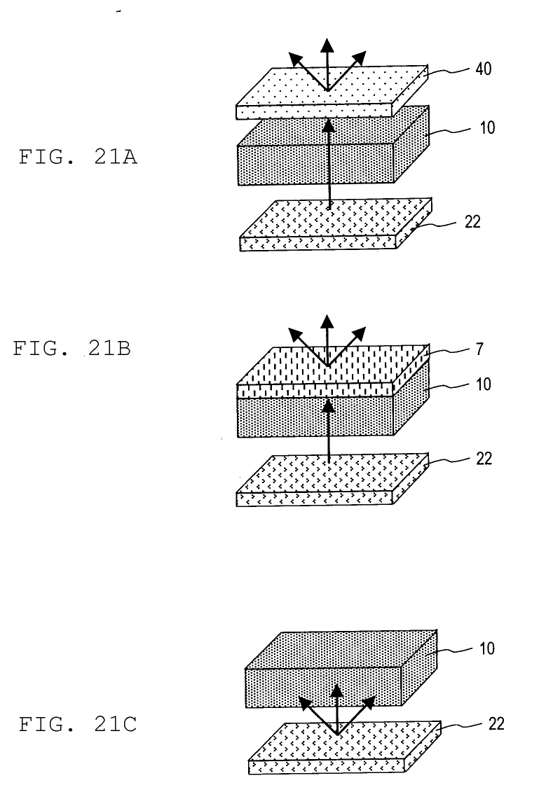

For example, as shown in FIG. 21A, a diffuser 40 may be placed on the observer side of the liquid crystal display panel 10 to allow light having passed through the liquid crystal display panel 10 to be diffused with the diffuser 40. Alternatively, as shown in FIG. 21B, a photonic crystal layer 7 having a photonic crystal structure may be placed on the observer side of the liquid crystal display panel 10, to allow light to be diffused with the photonic crystal layer 7.

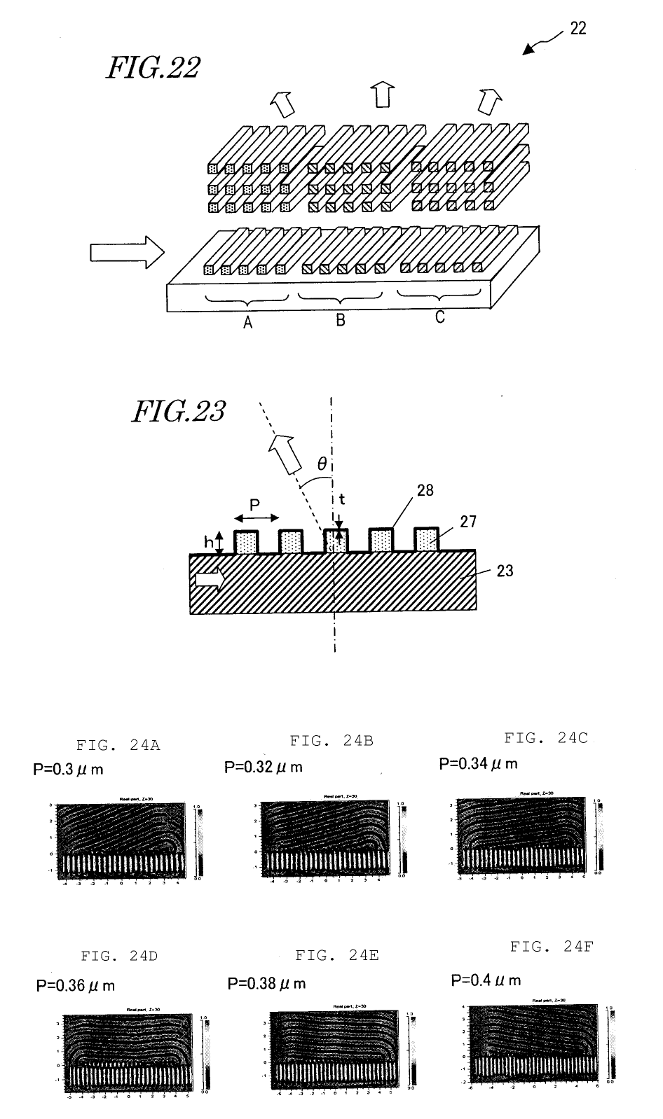

Otherwise, as shown in FIG. 21C, the photonic crystal structure may be designed in advance to allow light to emerge in a plurality of directions from the light guide 22. For example, as shown in FIG. 22, design may be made so that a region of the light guide 22 corresponding to one pixel is further divided into a plurality of regions A, B and C in which the directions of emergence are different from one another, so as to allow light to emerge in a plurality of directions from the region corresponding to one pixel. Specifically, to give different directions of emergence for the regions A, B and C, the period of the refractive index may be changed a little among the regions.

Hereinafter, part of the results of simulation performed on the relationship between the period of the refractive index and the direction of emergence will be described. As shown in FIG. 23, consider the situation that rectangular or substantially rectangular columns 27 made of a resin having a refractive index of 1.56 are formed on the surface of a glass substrate 23 having a refractive index of 1.56 and that a TiO₂ film 28 is formed to cover the rectangular or substantially rectangular columns 27. In this situation, assuming that the thickness t of the TiO₂ film 28 is 10 nm and the height h of the rectangular or substantially rectangular columns 27 is a half of the pitch P (P/2), simulation of the direction of emergence of light was performed by changing the pitch P in the range of about 0.3 μm to about 0.4 μm, for example. The results of the simulation are shown in FIGS. 24A to 24F.

From FIGS. 24A to 24F, it is found that the direction of emergence of light varies with the change of the pitch P. Specifically, while light emerges roughly in the front direction when the pitch P is 0.36 μm as shown in FIG. 24D, light emerges in a direction tilted leftward (counterclockwise) from the front as viewed from the figure when the pitch P is 0.3 μm, 0.32 μm and 0.34 μm as shown in FIGS. 24A, 24B and 24C, and emerges in a direction tilted rightward (clockwise) from the front as viewed from the figure when the pitch P is 0.38 μm and 0.4 μm as shown in FIGS. 24E and 24F.

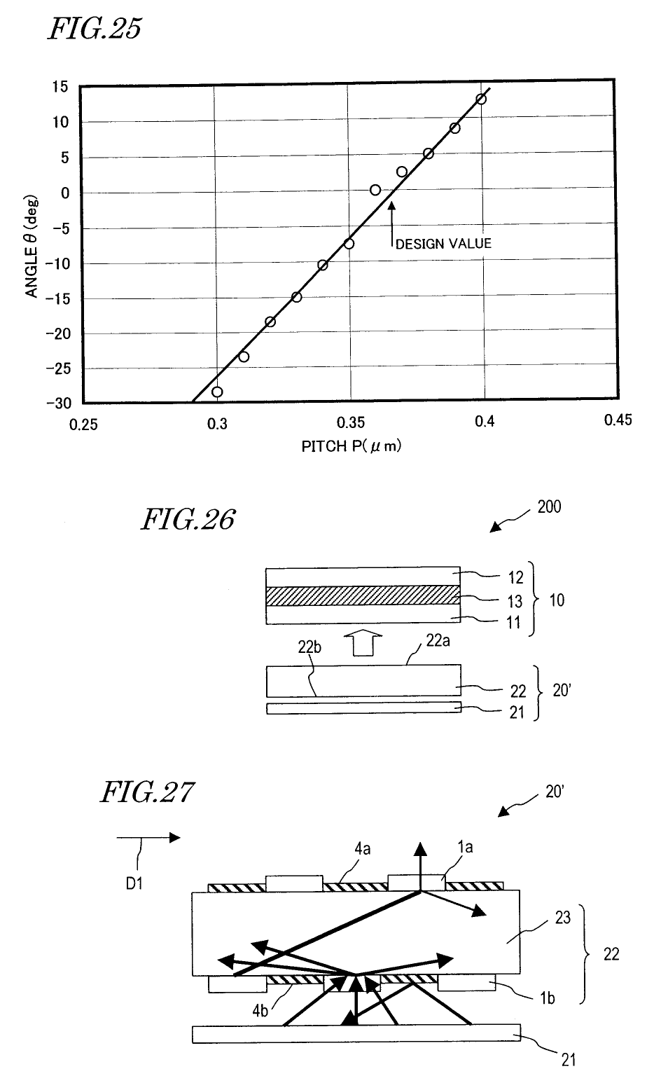

A specific relationship between the pitch P and the angle of emergence is shown in FIG. 25 and Table 3. As shown in FIG. 25 and Table 3, a roughly linear relationship is observed between the pitch P and the angle of emergence. It is therefore found that by slightly shifting the pitch P from the design value (about 0.36 μm in this case) corresponding to 0°, the angle of emergence can be set at an arbitrary angle other than 0°.

TABLE 3

| | Pitch P (μm) | | | | | | | | | | |
|---|---|---|---|---|---|---|---|---|---|---|---|
| | 0.30 | 0.31 | 0.32 | 0.33 | 0.34 | 0.35 | 0.36 | 0.37 | 0.38 | 0.39 | 0.40 |
| Angle of | −28.5 | −23.5 | −18.5 | −15 | −10.5 | −7.5 | 0 | 2.5 | 5 | 8.5 | 12.5 |
| emergence | | | | | | | | | | | |
| Θ (°) | | | | | | | | | | | |

### Preferred Embodiment 2

FIG. 26 shows a liquid crystal display device 200 of this preferred embodiment. The liquid crystal display device 200 includes a liquid crystal display panel 10 having a plurality of pixels and an illuminator 20′ placed on the back side of the liquid crystal display panel 10.

While the illuminator 20 of the liquid crystal display device 100 of Preferred Embodiment 1 has the light source 21 at a side of the light guide 22, the illuminator 20′ of the liquid crystal display device 200 of this preferred embodiment has a light source 21 below a light guide 22. That is, while the side plane 22c of the light guide 22 functions as the plane of incidence in the illuminator 20 in Preferred Embodiment 1, the back plane 22b of the light guide 22 functions as the plane of incidence in the illuminator 20′ in this preferred embodiment.

Hereinafter, the illuminator 20′ will be described in more detail with reference to FIG. 27. As shown in FIG. 27, the light guide 22 of the illuminator 20′ has a photonic crystal layer 1a placed on the surface of a transparent substrate 23 facing the liquid crystal panel 10 and a photonic crystal layer 1b placed on the surface of the transparent substrate 23 facing the light source 21.

Both the photonic crystal layers 1a and 1b have a refractive index periodic structure in which the refractive index changes periodically along the direction D1 substantially parallel to the plane of emergence 22a. In this preferred embodiment, therefore, the photonic crystal layers 1a and 1b and the photonic crystal structure thereof are also called the “first photonic crystal layer” and the “first photonic crystal structure”, respectively. The first photonic crystal structure of the first photonic crystal layers 1a and 1b preferably has the same structure as the first photonic crystal structure described in Preferred Embodiment 1.

The first photonic crystal layer 1b formed in each of a plurality of regions near the back plane 22b of the light guide 22 (such regions are called “back-side regions”) changes the traveling direction of light incident from the light source 21, as shown in FIG. 27, to allow the light to propagate in the horizontal direction inside the light guide 22.

The first photonic crystal layer 1a formed in each of a plurality of regions near the principal plane 22a of the light guide 22 (such regions are called “principal-side regions”) extracts light propagating inside the light guide 22 and directs it normal to the plane of emergence 22a, like the first photonic crystal layer 1 in Preferred Embodiment 1.

Like the light guide 22 in Preferred Embodiment 1, the light guide 22 in this preferred embodiment, having the photonic crystal structure, can improve the light use efficiency of the display device.

From the standpoint of using light more efficiently, as shown in FIG. 27, light reflection regions 4a are preferably provided between the adjacent first photonic crystal layers 1a on the principal plane 22a side (i.e., between the adjacent principal-side regions), and likewise light reflection regions 4b are preferably provided between the adjacent first photonic crystal layers 1b on the back plane 22b side (i.e., between the adjacent back-side regions).

A photonic crystal layer for further polarization separation and wavelength separation (corresponding to the second photonic crystal layer 2 in Preferred Embodiment 1) may be provided on each of the first photonic crystal layers 1a on the principal plane 22a side.

### Preferred Embodiment 3

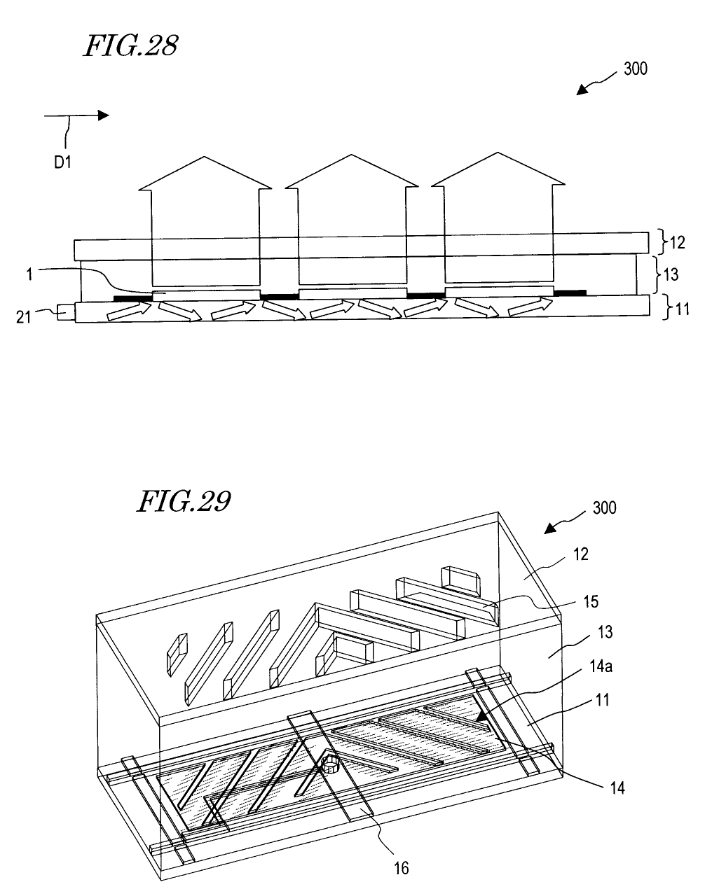

FIG. 28 shows a liquid crystal display device 300 of this preferred embodiment. The liquid crystal display device 300 has no illuminator, unlike the liquid crystal display devices 100 and 200 of Preferred Embodiments 1 and 2.

The liquid crystal display device 300 has a pair of substrates 11 and 12 and a liquid crystal layer 13 as a light modulation layer interposed between these substrates. As used herein, the substrate 11 placed on the back side of the liquid crystal layer 13 (opposite to the observer side) is called a “back substrate”, and the substrate 12 placed on the front side of the liquid crystal layer 13 (observer side) is called a “front substrate”. The back substrate 11 is an active matrix substrate, for example, and the front substrate 12 is a color filter substrate, for example.

The back substrate 11 has a principal plane (facing the liquid crystal layer 13) and a back plane opposing to each other and a plurality of side planes located between the principal plane and the back plane. A light source 21 is placed at a side of the back substrate 11, and the side surface facing the light source 21 functions as the plane of incidence receiving light (i.e., on which light is incident).

The back substrate 11 has a photonic crystal layer 1 provided for each of specific regions, or more specifically each of a plurality of pixels. The photonic crystal layer 1 has a refractive index periodic structure in which the refractive index changes periodically along the direction D1 substantially parallel to the principal plane of the back substrate 11. In this preferred embodiment, therefore, the photonic crystal layer 1 and the photonic crystal structure thereof are also called the “first photonic crystal layer” and the “first photonic crystal structure”, respectively. The first photonic crystal structure of the first photonic crystal layer 1 is substantially the same in structure as the first photonic crystal structure described in Preferred Embodiment 1.

The refractive index period of the first photonic crystal structure is different among red (R) pixels outputting red light, green (G) pixels outputting green light and blue (B) pixels outputting blue light.

In the liquid crystal display device 300 of this preferred embodiment, light emitted from the light source 21 enters the inside of the back substrate 11, and the light propagating in the back substrate 11 is extracted and directed normal to the principal plane of the back substrate 11 (i.e., normal to the display plane). In other words, by forming the first photonic crystal layer 1 on the back substrate 11, the back substrate 11 is allowed to function as a light guiding plate (light guide). In this preferred embodiment, also, the light use efficiency of the display device can be improved for the same reason as that described in Preferred Embodiment 1.

It is unnecessary to form the first photonic crystal structure over the entire of each pixel. By forming the first photonic crystal structure not to substantially overlap any light-shading member and orientation regulating members in the pixel, the light use efficiency can be further enhanced.

FIG. 29 shows an example of preferred positional relationship between light-shading members/orientation regulating members in a pixel and the first photonic crystal structure. FIG. 29 shows a MVA-mode pixel structure. As shown in FIG. 29, the first photonic crystal structure is formed not to overlap openings 14a and protrusions 15 and also formed not to overlap a storage capacitance line 16. Thus, light is allowed to be incident intensively only on regions of the pixel actually contributing to display.

The amount of light propagating inside the back substrate 11 becomes smaller as the position from the light source 21 is farther. Therefore, if the first photonic crystal structure is formed on the back substrate 11 at a uniform density, the uniformity of light emerging from the principal plane of the back substrate 11 may sometimes be low. In view of this, the first photonic crystal structure may be formed so that the proportion of the area of the regions having the photonic crystal structure in each unit area of the principal plane when viewed from the normal to the principal plane is greater as the position is farther from the plane of incidence in the principal plane. That is, the photonic crystal structure may be formed denser as the position is farther from the light source 21. In this way, the uniformity of light emerging from the principal plane can be made high.

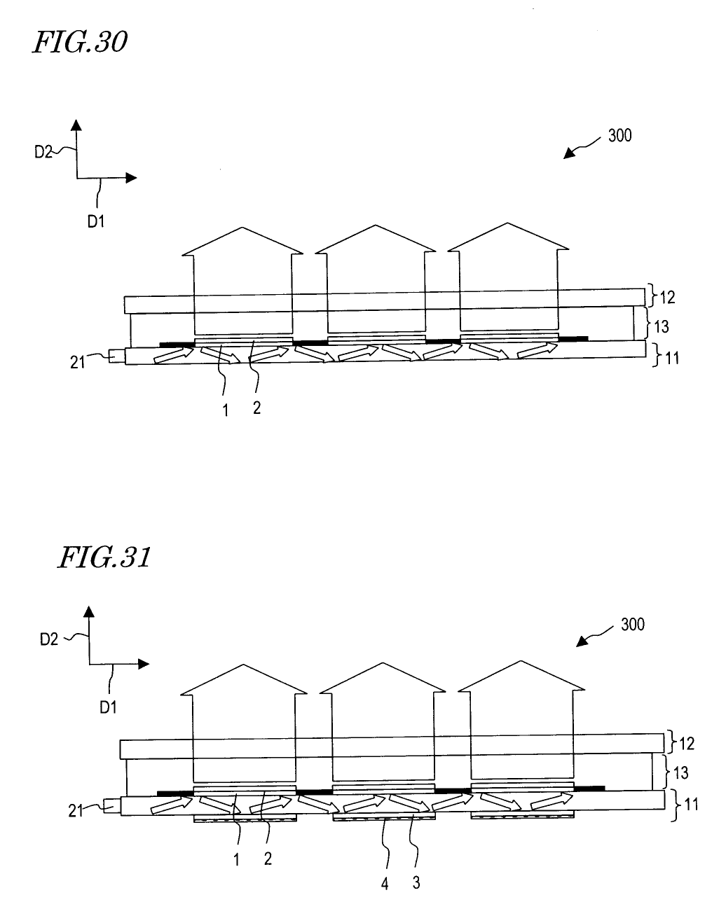

As in the light guide 22 shown in FIG. 6, a photonic crystal layer for further polarization separation and wavelength separation may be formed on the first photonic crystal layer 1. The back substrate 11 shown in FIG. 30 has a second photonic crystal layer 2 placed on the first photonic crystal layer 1. The second photonic crystal layer 2 has a second photonic crystal structure in which the refractive index changes along the direction D2 substantially vertical to the principal plane of the back substrate 11. In this way, with the formation of the second photonic crystal structure on the side of the first photonic crystal structure facing the liquid crystal layer 13, the polarization separation and the wavelength separation can be performed more reliably.

Also, as in the light guide 22 shown in FIG. 7, a photonic crystal layer that functions as a wide-band 1/4λ plate may be placed on the side of the back substrate opposite to the first photonic crystal layer 1. The back substrate 11 shown in FIG. 31 has a third photonic crystal layer 3 placed on the back plane side of the back substrate 11 and a light reflection layer 4 placed on the third photonic crystal layer 3.

The third photonic crystal layer 3 has a photonic crystal structure in which the refractive index changes periodically along a direction substantially parallel to the principal plane and crossing the direction D1 (at an angle of 45°, for example) and functions as a wide-band 1/4λ plate.

With the third photonic crystal layer 3 and the light reflection layer 4 placed in the above manner, the polarization direction of light made to travel toward the side opposite to the liquid crystal layer 13 by the first photonic crystal layer 1 can be rotated about 90°. The light traveling toward the opposite side can therefore be extracted with the first photonic crystal layer 1.

Also, as in the light guide 22 shown in FIG. 27, it is possible to adopt a structure that first photonic crystal layers and light reflection layers are formed on both the principle-plane and back-plane sides of the back substrate 11 and light is incident on the back plane of the back substrate 11.

The light guide and the display device substrate according to various preferred embodiments of the present invention utilize the characteristic of photonic crystal of being able to selectively extract light in a specific wavelength range and light having a specific polarization direction with high energy efficiency. The light use efficiency of the display device can therefore be improved.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-51. (canceled)

52: A light guide having a plane of incidence on which light is incident and a plane of emergence from which light emerges, the light guide comprising:
a photonic crystal structure having a refractive index changing periodically along a direction substantially parallel to the plane of emergence.

53: The light guide of claim 52, wherein the photonic crystal structure is selectively provided in specific regions of the light guide.

54: The light guide of claim 53, wherein the specific regions include a first region having a refractive index changing at a first period, a second region having a refractive index changing at a second period different from the first period, and a third region having a refractive index changing at a third period different from the first and second periods.

55: The light guide of claim 52, wherein the photonic crystal structure is a first photonic crystal structure and the direction substantially parallel to the plane of emergence is a first direction, the light guide further comprising a second photonic crystal structure having a refractive index changing periodically along a second direction substantially vertical to the plane of emergence.

56: The light guide of claim 55, wherein the second photonic crystal structure is located in regions nearer to the plane of emergence than the regions in which the first photonic crystal structure is located.

57: The light guide of claim 52, wherein the light guide has a principal plane and a back plane opposite to each other and a plurality of side planes located between the principal plane and the back plane.

58: The light guide of claim 57, wherein the plurality of side planes include a side plane defining the plane of incidence, and the principal plane defining the plane of emergence.

59: The light guide of claim 55, further comprising a third photonic crystal structure having a refractive index changing periodically along a third direction substantially parallel to the plane of emergence and crossing the first direction.

60: The light guide of claim 59, wherein the third photonic crystal structure is located in regions farther from the plane of emergence than the regions in which the first photonic crystal structure is located.

61: The light guide of claim 60, further comprising a light reflection layer disposed on the side of the regions in which the third photonic crystal structure is located opposite to the plane of emergence.

62: The light guide of claim 58, wherein an occupation of the area of the regions in which the first photonic crystal structure is located in the unit area of the plane of emergence when viewed from a normal to the plane of emergence is greater as the position is farther from the plane of incidence in the plane of emergence.

63: The light guide of claim 57, wherein the back plane defines the plane of incidence, and the principal plane defines the plane of emergence.

64: The light guide of claim 63, wherein the photonic crystal structure is located in a plurality of principal-side regions located near the principal plane and in a plurality of back-side regions located near the back plane.

65: The light guide of claim 64, further comprising at least one principal-side light reflection layer located between the plurality of principal-side regions and at least one back-side light reflection layer located between the plurality of back-side regions.

66: An illuminator comprising:
a light source; and
the light guide of claim 52 arranged to guide light emitted from the light source in a predetermined direction.

67: A display device comprising:
the illuminator of claim 66; and
a display panel having a plurality of pixels and arranged to perform display using light emerging from the illuminator.

68: The display device of claim 67, wherein the light guide has the photonic crystal structure for each region corresponding to each of the plurality of pixels of the display panel.

69: The display device of claim 68, wherein light emerges from the region of the light guide corresponding to each of the plurality of pixels in a plurality of directions.

70: The display device of claim 67, wherein the photonic crystal structure is located in a region that does not substantially overlap a light-shading member in the display panel.

71: The display device of claim 67, further comprising a first substrate and a second substrate, wherein the first substrate and/or the second substrate has an orientation regulating member provided for each of the plurality of pixels, and the photonic crystal structure is located in a region that does not substantially overlap the orientation regulating member.

72: A display device substrate having a principal plane and a back plane opposite to each other and a plurality of side planes located between the principal plane and the back plane, the substrate comprising:
a photonic crystal structure having a refractive index changing periodically along a direction substantially parallel to the principal plane.

73: The display device substrate of claim 72, wherein the photonic crystal structure is selectively provided in specific regions of the substrate.

74: The display device substrate of claim 73, wherein the specific regions include a first region having a refractive index changing at a first period, a second region having a refractive index changing at a second period different from the first period and a third region having a refractive index changing at a third period different from the first and second periods.

75: The display device substrate of claim 72, wherein the photonic crystal structure is a first photonic crystal structure and the direction substantially parallel to the plane of emergence is a first direction, the substrate further comprising a second photonic crystal structure having a refractive index changing periodically along a second direction substantially vertical to the principal plane.

76: The display device substrate of claim 75, wherein the second photonic crystal structure is located in regions nearer to the principal plane than the regions in which the first photonic crystal structure is located.

77: The display device substrate of claim 75, further comprising a third photonic crystal structure having a refractive index changing periodically along a third direction substantially parallel to the principal plane and crossing the first direction.

78: The display device substrate of claim 77, wherein the third photonic crystal structure is located in regions nearer to the back plane than the regions in which the first photonic crystal structure is located.

79: The display device substrate of claim 78, further comprising a light reflection layer located on the back plane side of the regions in which the third photonic crystal structure is located.

80: The display device substrate of claim 72, wherein an occupation of the area of the regions in which the first photonic crystal structure is located in the unit area of the principal plane when viewed from a normal to the principal plane is greater as the position is farther from a given side plane among the plurality of side planes in the principal plane.

81: The display device substrate of claim 72, wherein the photonic crystal structure is located in a plurality of principal-side regions located near the principal plane and in a plurality of back-side regions located near the back plane.

82: The display device substrate of claim 81, further comprising at least one principal-side light reflection layer disposed between the plurality of principal-side regions and at least one back-side light reflection layer disposed between the plurality of back-side regions.

83: A display device having a plurality of pixels, comprising:
a first substrate;
a second substrate opposing to the first substrate; and
a light modulation layer interposed between the first and second substrates; wherein
the first substrate is the display device substrate of claim 72.

84: The display device of claim 83, wherein the first substrate has the photonic crystal structure for each of the plurality of pixels.

85: The display device of claim 83, wherein the photonic crystal structure is located in a region that does not substantially overlap a light-shading member.

86: The display device of claim 83, wherein the first substrate and/or the second substrate has an orientation regulating member provided for each of the plurality of pixels, and the photonic crystal structure is located in a region that does not substantially overlap the orientation regulating member.

87: A display device having a plurality of pixels, comprising:
a first substrate having a principal plane;
a second substrate opposing to the first substrate; and
a light modulation layer interposed between the first and second substrates; wherein
the first substrate has a photonic crystal structure having a refractive index changing periodically along a direction substantially parallel to the principal plane for each of the plurality of pixels.

88: The display device of claim 87, wherein the plurality of pixels include first color pixels outputting first color light, second color pixels outputting second color light different from the first color light, and third color pixels outputting third color light different from the first color light and the second color light,
the photonic crystal structure in the first color pixels has a first period,
the photonic crystal structure in the second color pixels has a second period different from the first period, and
the photonic crystal structure in the third color pixels has a third period different from the first period and the second period.

89: The display device of claim 87, wherein the photonic crystal structure is located in a region that does not substantially overlap a light-shading member.

90: The display device of claim 87, wherein the first substrate and/or the second substrate has an orientation regulating member provided for each of the plurality of pixels, and the photonic crystal structure is located in a region that does not substantially overlap the orientation regulating member.

91: The display device of claim 87, wherein the photonic crystal structure is a first photonic crystal structure and the direction substantially parallel to the plane of emergence is a first direction, and the first substrate has a second photonic crystal structure having a refractive index changing periodically along a second direction substantially vertical to the principal plane.

92: The display device of claim 91, wherein the second photonic crystal structure is located in regions nearer to the principal plane than regions in which the first photonic crystal structure is located.

93: The display device of claim 87, further comprising a light source.

94: The display device of claim 93, wherein the first substrate further has a back plane opposite to the principal plane and a plurality of side planes located between the principal plane and the back plane, and
the plurality of side planes include a side plane on which light emitted from the light source is incident.

95: The display device of claim 91, wherein the first substrate has a third photonic crystal structure having a refractive index changing periodically along a third direction substantially parallel to the principal plane and crossing the first direction.

96: The display device of claim 95, wherein the third photonic crystal structure is located in regions farther from the principal plane than the regions in which the first photonic crystal structure is located.

97: The light guide of claim 96, wherein the first substrate has a light reflection layer disposed on the side of the regions in which the third photonic crystal structure is opposite to the principal plane.

98: The display device of claim 94, wherein in each of the plurality of pixels, an occupation of the area of the regions in which the photonic crystal structure is located in the principal plane when viewed from a normal to the principal plane is greater as the position of the pixel is farther from the side plane on which light is incident.

99: The display device of claim 93, wherein the first substrate further has a back plane opposite to the principal plane and a plurality of side planes located between the principal plane and the back plane, and
light emitted from the light source is incident on the back plane.

100: The display device of claim 99, wherein the photonic crystal structure is located in a plurality of principal-side regions located near the principal plane and in a plurality of back-side regions located near the back plane.

101: The display device of claim 100, wherein the first substrate has at least one principal-side light reflection layer formed between the plurality of principal-side regions and at least one back-side light reflection layer disposed between the plurality of back-side regions.

102: The display device of claim 83, wherein the light modulation layer is a liquid crystal layer.
